(19) United States
(12) Patent Application Publication
(10) Pub. No.: US 2020/0083733 A1
(43) Pub. Date: Mar. 12, 2020

(54) Multi-Channel Intelligent Charger

(71) Applicant: PHIHONG TECHNOLOGY CO., LTD., Taoyuan City (TW)

(72) Inventors: Huang-Chang Chang, Tainan City (TW); Jiun-Ping Huang, Tainan City (TW); Mu-Hsun Chen, Taoyuan City (TW)

(21) Appl. No.: 16/231,345

(22) Filed: Dec. 21, 2018

(30) Foreign Application Priority Data
Sep. 7, 2018 (TW) 107131549

(51) Int. Cl. H02J 7/00; H02J 7/02

(52) U.S. Cl. CPC H02J 7/0072; H02J 7/022; H02J 7/0013

(57) ABSTRACT

The present invention is a multi-channel intelligent charger, including: power module, providing electric power needed the multi-channel intelligent charger for operation, control module, coupling to power module for controlling the operation of multi-channel intelligent charger, circuit switch module, coupling to control module for switching charging mode, which basis on circumstances of charging, detect module, coupling to circuit switch module, detecting the circumstances of charging, and, charge module, outputting the charging power.

### CROSS-REFERENCE TO RELATED APPLICATIONS

The present application is based on, and claims priority from, Taiwan Application Serial Number 107131549, filed Sep. 7, 2018, the disclosure of which is hereby incorporated by reference herein in its entirety.

### TECHNICAL FIELD

The present invention relates to a multi-channel intelligent charger, and more particularly, an intelligent charger for charging one or multiple battery simultaneously and the charge current and charge rate are adjustable based on the residual electric energy.

### BACKGROUND

Since the 19th century, electric power began to have wide applications in human life, electric devices have become more and more of crucial to daily life, except to the fixed devices which use fixed electric power, various portable devices employ batteries which store electric energy as a source of electric power. Most of the portable devices have built-in high-performance microprocessor, resulting to consuming much more electric energy. Therefore, the development of high-performance chargers has never stopped.

When commonly used charger is in operation, the commercial electric power must be converted alternating current (AC) into the direct current (DC) required for the electric devices via the rectifier, and then regulate the direct current through the other circuits required of the battery. During the pastime, the focus of improvement on charger was electric voltage conversion efficiency of the DC. The development history of charger could be distinguished with linear-type converter and switch-type converter. The linear-type converter, please refer to FIG. 1A, which controls the desired output voltage range 0-V_{R} through the semiconductor switch in the circuit. In the circumstances mentioned above, the semiconductor switch is equivalent to a variable resistor R, so the electric power loss is quite large, resulted in not only very high working temperature, but also low conversion efficiency.

For overcoming low conversion efficiency of linear-type converter, switch-type converter has been developed, please refer to FIG. 1B, switch-type converter mainly compressed by several inductances and capacitances, by using Pulse Width Modulation (PWM), the high-voltage electric power is directly inputted into the rectification filter circuit (said rectification filter circuit may be passive or active) which obtained from the commercial electric power. In the FIG. 1B, the semiconductor Q is equivalent to a circuit switch, but variable resistor R in linear-type converter. The DC is decomposed to square wave, then reduced voltage by high frequency electric transformer, finally acquire the need of voltage via filtering circuit, the conversion efficiency is much higher than linear-type converter.

However, even the conversion efficiency has been improved a lot, the commonly used charger with one or multiple channels, which has the function to charge one or multiple batteries, still lacking a charger which could detect the state of each battery under charging, or the charging conditions applicable to each battery. The adjustment of the voltage or current input during charging process is also impossible, not to mention the adjustment of charging rate, charging voltage, charging current, and charging sequence when the spec of the batteries in the channels are different, making the commonly used charger cost too much time for charging batteries.

In the prior art, although some of manufacturers have proposed charging device which comprise plurality of chargers attempting to solve the problem as mentioned above, yet the structure of said charging device were only selecting the independent charger in the charging device to process charging according to charge condition, it still lacks ability which could optimize charging efficiency by tuning charging current according to the number of batteries placed in each channel and the electric energy storage. Therefore, there is still need for a multi-channel intelligent charger, which could determine the charging sequence and current of the batteries by detecting the amount of electric energy stored and numbers of battery, for fully utilizing the performance of the charger to charge multiple batteries simultaneously and reducing cost of charging time.

### SUMMARY

In view of the disadvantages in the prior art, the present invention provides a multi-channel intelligent charger looking forward to improve the performance of traditional charger, including: power module, providing electric power needed the multi-channel intelligent charger for operation, control module, coupling to power module for controlling the operation of multi-channel intelligent charger, circuit switch module, coupling to control module for switching charging mode, which basis on circumstances of charging, detect module, coupling to circuit switch module, detecting the circumstances of charging, and, charge module, coupling to detect module, outputting the charging power.

According to the content of present invention, the multi-channel intelligent charger further comprising switch module, coupling the circuit switch module, controlling whether the electric power of charge module is conductive or not. In one aspect of the present invention, switch module further comprises plurality switch units connecting in parallel, provided the multi-channel intelligent charger with redundant structure, thus the electric power output of charge module would not malfunction simultaneously while one or some of switch unit(s) is faulty, which could raise the reliability of multi-channel intelligent charge.

According to the content of the present invention, charge module further comprises plurality charge channels connecting in parallel, charging the batteries placed in charge channels, in the embodiment of the present invention, numbers of charging channels could be configured on the basis of the needs of the application.

According to one aspect of the present invention, the power module mentioned as above further comprising rectifier unit, converting alternating current (AC) into the direct current (DC).

According to the content of the present invention, the power module mentioned as above further comprising power output unit which to couple the rectifier unit, lowering or raising DC voltage of electric power required by the charge module.

According to the content of present invention, the power module further comprising feedback unit, outputting voltage and current in accordance with a reference value to adjust the output electric power, when the instantaneous change of the output voltage or current is greater or less than the reference value, the instantaneous change is fed to the power output unit for adjusting the electric power output, making multi-channel intelligent charger able to supply battery stable charging current. In one aspect of the present invention, the feedback unit includes a reference value circuit, a plurality of amplifiers which could generate different gains and corresponding to different electric power supply bandwidths, and a power transistor.

According to the content of present invention, the power module further comprising STby unit, coupling to control module, making the multi-channel intelligent charger to enter standing-by state when stop operating. Similarly, when the detect module detects that the charge module has a charging requirement, the multi-channel intelligent charger is activated to enter the working state.

### BRIEF DESCRIPTION OF THE DRAWINGS

The components, characteristics and advantages of the present invention may be understood by the detailed descriptions of the preferred embodiments outlined in the specification and the drawings attached:

FIG. 1A illustrates the circuit structure of linear-type converter in prior art.

FIG. 1B illustrates the circuit structure of switch-type converter in prior art.

FIG. 2 illustrates the structure of multi-channel intelligent charger in the present invention.

FIG. 3 illustrates the detail structure of power module in one embodiment of the present invention.

FIG. 4 illustrates the structure of multi-channel intelligent charger in one embodiment of the present invention.

FIG. 5A illustrates one of the application when electric power charge is processed.

FIG. 5B illustrates another one of application when electric power charge is processed.

FIG. 5C illustrates the other one of the application scenarios when electric power charge is processed.

FIG. 6 illustrates the circuit structure of feedback unit in one embodiment of the present invention.

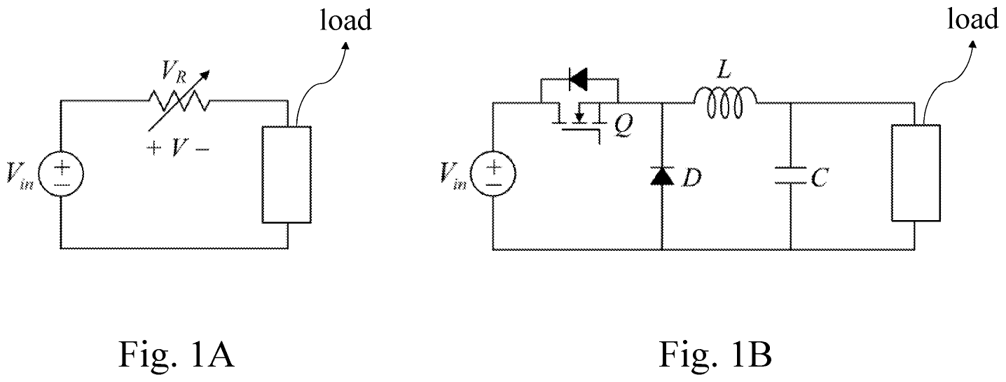

### DETAILED DESCRIPTION

Some preferred embodiments of the present invention will now be described in greater detail. However, it should be recognized that the preferred embodiments of the present invention are provided for illustration rather than limiting the present invention. In addition, the present invention can be practiced in a wide range of other embodiments besides those explicitly described, and the scope of the present invention is not expressly limited except as specified in the accompanying claims.

The purpose of the present invention is to solve the charging device in the prior art, although a plurality of batteries could be placed simultaneously, however, if the residual electric power and voltage of each battery are different from each other, then the voltage-current diagram (I-V diagram) would exhibit different charging characteristics of each battery, thus it is not possible to charge all the batteries at the same time in reality application. The proposal in the present invention for solving the above problems is to detect the residual electric power, state and numbers of the battery (213) via detect module (209) to determine the charging sequence of the battery (213) and the current. Also, circuit switch module (205) switches the charging mode of the charge module (211) coupled to the power module (201) according to the condition of the electric power required by the battery (213) during charging, so that it could be adapted to the corresponding charging condition of the battery (213), changing charge current and voltage to achieve the purpose of simultaneously charging to different specs or residual electric power of batteries (213).

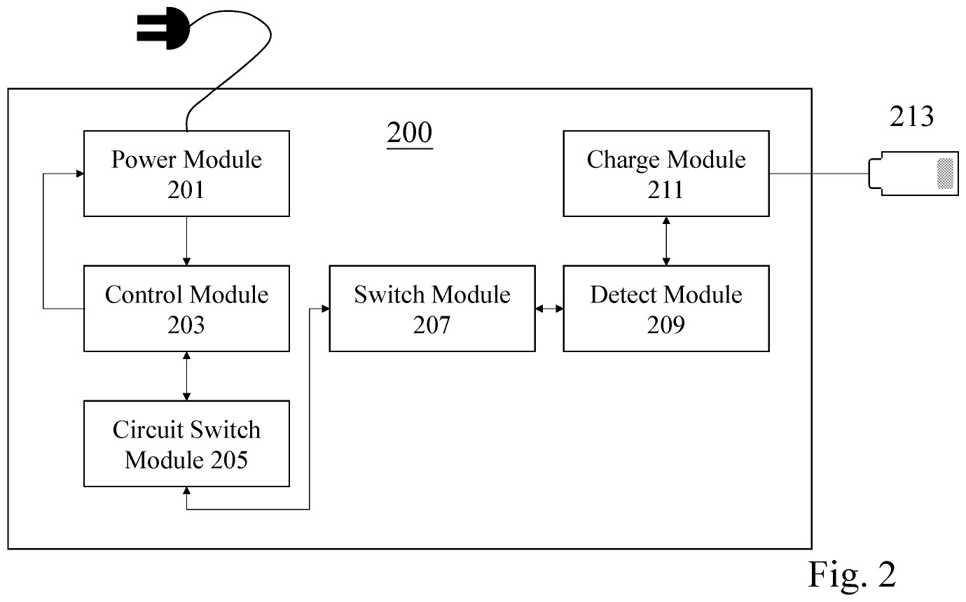

Accordingly, in order to reach the purpose above, please refer to FIG. 2, the present invention provides a multi-channel intelligent charger (200), it comprises a power module (201) for providing electric power needed the multi-channel intelligent charger (200) for operation, a control module (203) is coupled to the power module (201) to control the operation of multi-channel intelligent charger (200), a circuit switch module (205) is coupled to the control module (203) for switching charging mode, which basis on circumstances of charging, a detect module (209) is coupled to the circuit switch module (205) to detect the circumstances of charging, and a charge module (211) is coupled to detect module (209) for outputting the charging power.

In the light of one embodiment of the present invention, detect module (209) further comprising thermal sensor. The control module (203) cuts off the electric power supply from power module (201) according to temperature detected via thermal sensor, when the temperature is higher than the predetermined value to avoid the accidents caused by excessive temperature of multi-channel intelligent charger (200). In one aspect of the present invention, the thermal sensor could be a thermistor, the control module (203) converted the mathematical relationship between the impedance changing rate of thermistor and the amount of temperature, obtaining actual temperature. The mathematical relationship is inversely proportional.

According to an embodiment of the present invention, the control module (203) usually comprise central processing unit, memory, timer/counter, various input/output interfaces, which are integrated on an microchip, providing the function of calculation, temporary data storage, data storage, data transmission, operation and management of multi-channel intelligent charger (200) by coupling with the other components of the present invention with well-known manner. Since the person skilled in the art should easy to understand the structure of control module (203), therefore the details of control module (203) would not be described here.

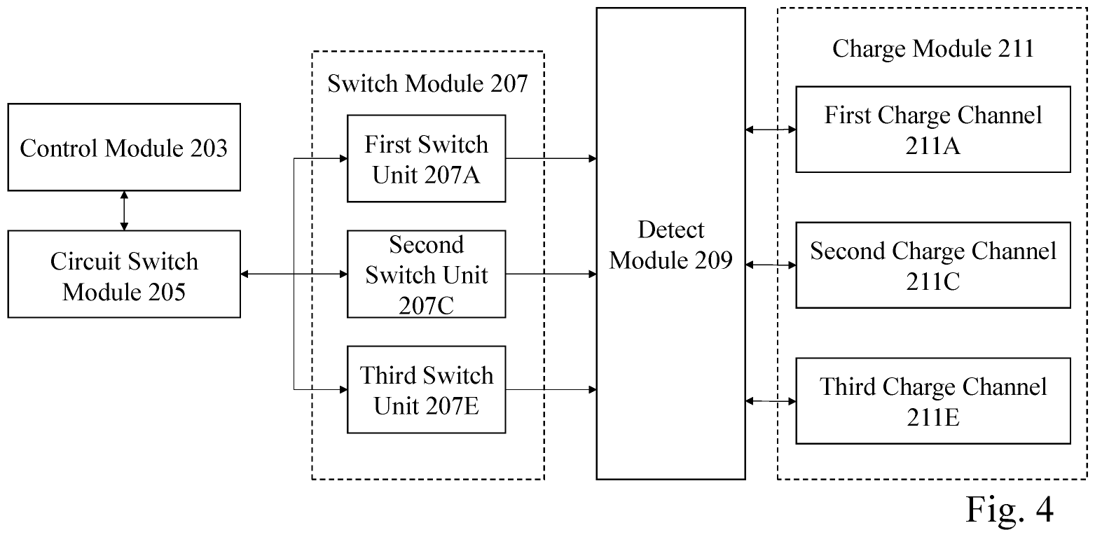

Please refer to FIG. 4, according to an embodiment of the present invention, circuit switch module (205) includes n transistors (n>1), wherein the sort of transistors could be, but not limit to DEPFET, DGMOFET, FREDFET, HEMT, IGBT, MOSFET, NOMFET, MODFET, OFET, which is adjustable in accordance with the needs of the application. Circuit switch module (205) has several characteristics, including low electric power consumption, fast switching time, high temperature stability and not easy to overheat, improving the electric power conversion efficiency of the multi-intelligent charger (200), also reducing the risk of accidents owing to overheat of the device.

According to the content of present invention, the multi-channel intelligent charger (200) further comprises the switch module (207), coupling the circuit switch module (205), controlling whether the electric power of charge module (211) is conductive or not. In a preferred embodiment of the present invention, the switch module (207) includes, but not limit to three switch units connecting in parallel: a first switch unit (207A), a second switch unit (207C), and a third switch unit (207E), which are adjustable in accordance with the needs of the application, wherein the sort of switch unit could be, but not limit to DEPFET, DGMOFET, FREDFET, HEMT, IGBT, MOSFET, NOMFET, MODFET, OFET, which is coupling with the circuit switch module (205) in the manner of back to back, provided the multi-channel intelligent charger (200) with redundant structure, thus the electric power output of charge module (211) would not malfunction simultaneously while one or some of switch unit(s) is faulty, which could raise the reliability of multi-channel intelligent charge (200).

As mentioned above, the configuration with the first switch unit (207A), the second switch unit (207C), and the third switch unit (207E) in switch module (207) is only one of embodiments of the present invention and could be commonly referred as a switch unit, which the amount may be greater than or equal to 1. The person skilled in the art should easy to understand the number of switch unit is adjustable in accordance with the needs of the application.

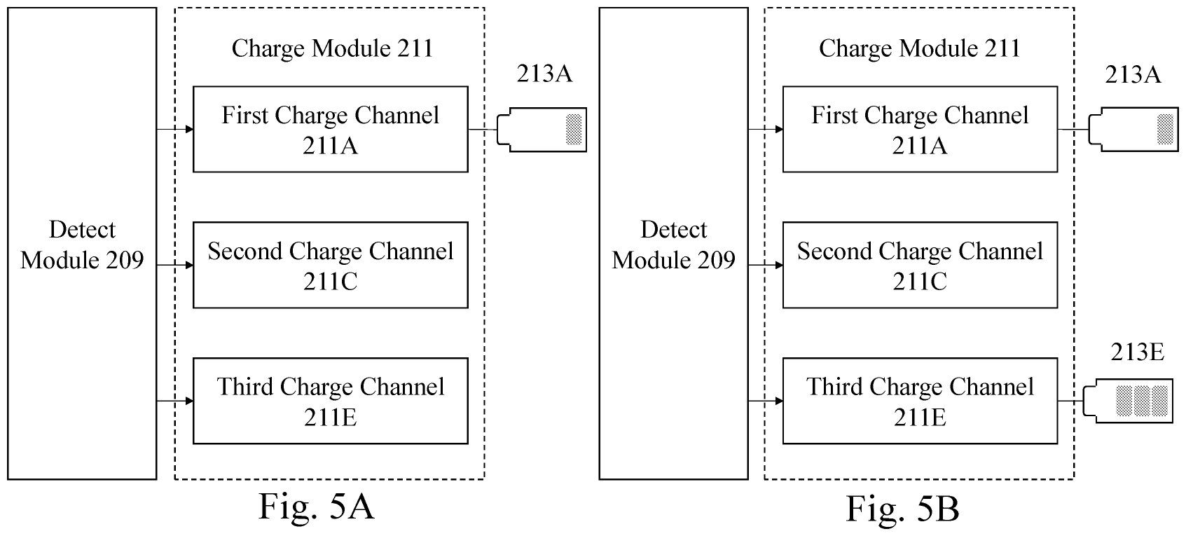

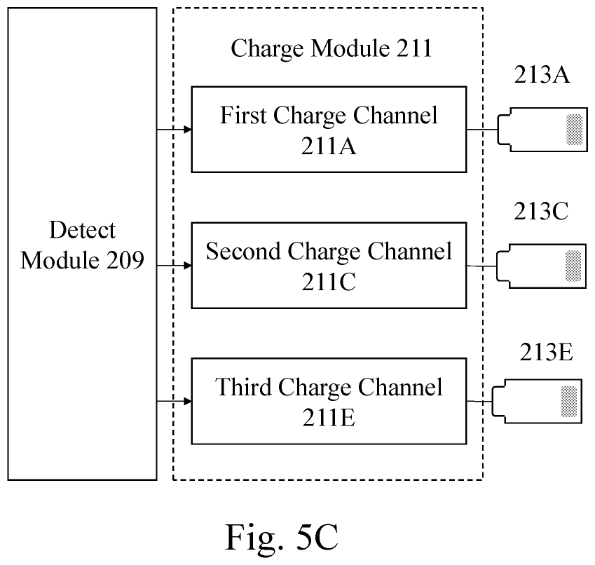

Please refer to FIG. 5A, which illustrates switch module (207) and circuit switch module (205) in one of the application embodiment in the present invention, wherein the first charge channel (211A) is connected to one battery (213). When control module (203) detects the first voltage of first battery (213A) through the detect module (209), the circuit switch module (205) then activates the first switch unit (207A), deactivates the second switch unit (207C) and the third switch unit (207E), and followed by charging the first battery (213A) via the first voltage, in the meantime, the charging current originally supplying to the second charge channel (211C) and the third charge channel (211E) is fed to the first charge channel (211A) by the deactivation of the second switching unit (207C) and the third switching unit (207E). Thus, the charging current output via the first charge channel (211A) is thereby increasing, also reducing the charging time, reaching one of the purposes in the present invention, namely, the changing current and charging voltage could be adjusted for different charging circumstances at any time.

Please refer to FIG. 5B, which illustrates the switch module (207) and the circuit switch module (205) in another application of an embodiment in the present invention, wherein the first charge channel (211A) and the third charge channel (211E) are connected to the first battery (213A) and the third battery (213E) battery, respectively. Under the application, the selection of low battery priority charging mode or self-selection charging mode could be chosen by multi-channel intelligent charger (200) through the control module (203). In one aspect of the present invention, if low battery priority charging mode is chosen, after the first charging voltage and the third charging voltage corresponding to the first battery (213A) and third battery (213E) are detected by the detect module (209), the circuit switch module (205) then activates the first switch unit (207A), the third switch unit (207E) and deactivate the second switch unit (207C), the charging current originally supplying the second charge channel (211C) is fed to the first charge channel (211A), resulting in the charging current output via the first charge channel (211A) is increased. In additional, the circuit switch module (205) supplies normal amount of charging current to the third charge channel (211E), so that the first battery (213A) and the third battery (213E) could input different charging currents according to different residual electric power, reaching another one of the purposes in the present invention. Furthermore, under the low battery priority charging mode, since the residual electric power of plurality batteries (213) are different, it could not only charge all the batteries (213) simultaneously, but also offers protective effect on multi-intelligent charger (200), in particular speaking, it is able to avoid over charging which results backward current, thereby causing damage to the device while increasing the charging current of battery (213).

As mentioned above, in the other aspect of the present invention, while self-selection charging mode is chosen, the circuit switch module (205) switches the charging current from the second charge channel (211C) to the third charge channel (211E), resulting in the charging current output via the third charge channel (211E) is increased, and the circuit switch module (205) supplies the normal amount of charging current by the first charge channel (211A), so that the third battery (213E) could be fully charged in a short period of time.

Please refer to FIG. 5C, which illustrates the switch module (207) and the circuit switch module (205) in the other application of multi-channel simultaneous charging mode in the embodiment, wherein the first charge channel (211A), the second charge channel (211C), the third charge channel (211A) are connected to the first battery (213A), the second battery (213C) and the third battery (213E), respectively. Under such application, after the first charging voltage, the second charging voltage, and the third charging voltage corresponding to the first battery (213A), the second battery (213C) and the third battery (213E) are detected via the detect module (209), the circuit switch module (205) activates the first switch unit (207A), the second switch unit (207C), the third switch unit (207E), feeding the charging current to the first charge channel (211A), the second charge channel (211C) and the third charge channel (211A) to allow multi-channel intelligent charger (200) could simultaneously charge plurality of batteries (213).

In the present invention, the first charge channel (211A), the second charge channel (211C) and the third charge channel (211A) are only embodiments and could be commonly referred as a charging channel unit, which the amount may be greater than or equal to 1. The person skilled in the art should easy to understand the number of charging channel unit is adjustable in accordance with the needs of the application.

In the present invention, the type, the configuration and the number of the battery (213) are only embodiments, the amount may be greater than or equal to 1. The person skilled in the art should easy to understand the number of batteries (213A) is changeable in accordance with the needs of the application.

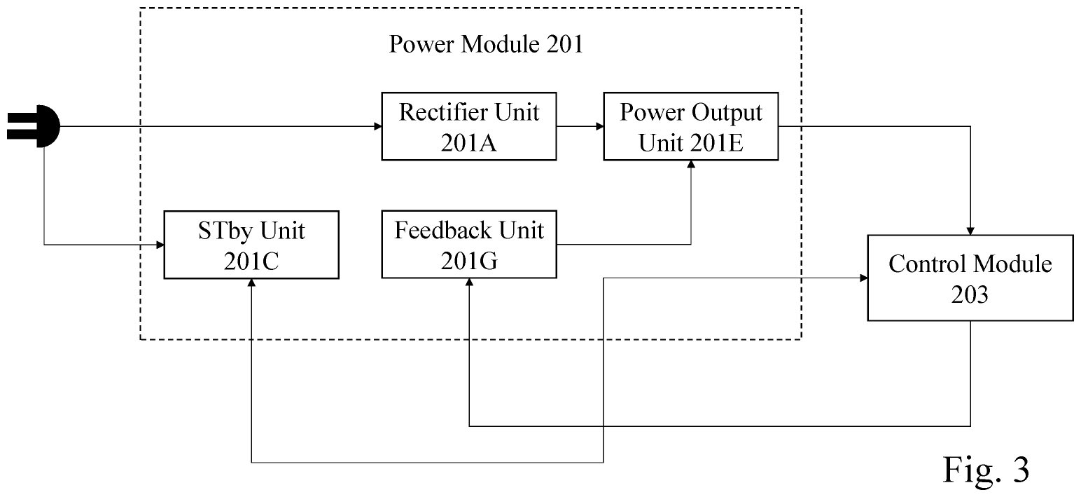

Please refer to FIG. 3, according to an embodiment of the present invention, the power module (201) comprises a rectifier unit (201A) for converting the input electric power from alternating current (AC) to direct current (DC). In one aspect of the present invention, the process of conversion between AC and DC could be, but not limited to full-wave rectification or half-wave rectification. Through the above conversion to DC, the rectifying unit (201A) transmits electric power to a power factor correction (PFC) circuit to smooth the output DC voltage, improve the power factor, and reduce the harmonic distortion. The power factor correction circuit could be passive or active power factor correction, depending on the application.

In line with one aspect of the present invention, the passive power factor correction circuit comprises plural inductances to compensate the phase difference between rectified current and voltage for improving power factor through the inductances. It is because that these electrical devices require less operating power (less than 400 W), it results that the DC voltage smooth compensation by the inductances would yield the benefits of simple structure, cost-effective, comprehensive and better performance, the power factor of passive power factor correction circuit is between 0.65 and 0.85.

In line with another one aspect of the present invention, active power factor correction mainly controls waveform of fundamental current through pulse width modulation (PWM) to trigger the transistors in the active power factor correction circuit, and then these pulse signals pass through the filter capacitors, outputting relatively smooth DC electric power, which the power factor could have effectiveness greater than 0.85-0.99. In the present invention, the rectifier unit (201A) could be chosen from passive or active power factor correction circuit in accordance with the needs of the application, and active power factor correction circuit is chosen in the preferred embodiment.

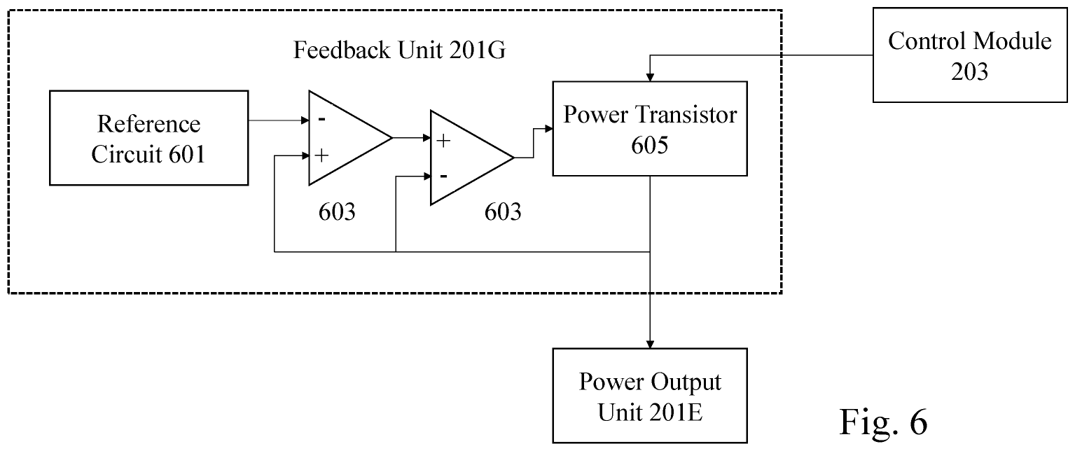

Please refer to FIG. 3, according to the content of present invention, the power module (201) further comprises the feedback unit (201G), which compare input electric power in accordance with reference value, while the instantaneous change of the output electric power is greater or less than the reference value, the instantaneous change of the output electric power is fed to the power output unit (201E) for adjustment to stabilize the input electric power to multi-channel intelligent charger (200). Please refer to FIG. 6, in one embodiment, the feedback unit (201G) comprises a reference circuit (301), an amplifier (603) and a power transistor (605). The main structure of the feedback unit (201G) includes at least one amplifier (603) with different gain and bandwidth connecting in series, coupling the reference circuit (301) to provide reference value, and power transistor (605). In the circuit structure as mentioned above, said control module (203) provides different bandwidth feedback path by connecting at least one amplifier (603) with different gain and bandwidth in parallel to extend capable range of bandwidth and gain.

According to the content of present invention, the power module (201) comprises a power output unit (201E) and a rectifier unit (201A), in one embodiment, the DC electric power is converted by the power transistor (605) in the power output unit (201E) and the ratio between the primary side winding and secondary side winding of the transformer, which the output DC voltage raising or lowering for the need of multi-channel intelligent charger (200).

According to the content of present invention, the power module (201) further comprises a STby unit (201C), coupling to control module (203), making the multi-channel intelligent charger (200) to enter standing-by state when the operation is ceased. Similarly, when the detect module (209) detects the charging requirement of the charge module (211), the multi-channel intelligent charger (200) is activated to enter the working state.

As will be understood by persons skilled in the art, the foregoing preferred embodiment of the present invention illustrates the present invention rather than limiting the present invention. Having described the invention in connection with a preferred embodiment, modifications will be suggested to those skilled in the art. Thus, the invention is not to be limited to this embodiment, but rather the invention is intended to cover various modifications and similar arrangements included within the spirit and scope of the appended claims, the scope of which should be accorded the broadest interpretation, thereby encompassing all such modifications and similar structures. While the preferred embodiment of the invention has been illustrated and described, it will be appreciated that various changes can be made without departing from the spirit and scope of the invention.

What is claimed is:

1. A multi-channel intelligent charger, comprising:
a power module to provide operation electric power;
a control module coupled to the power module to control said multi-channel intelligent charger;
a circuit switch module coupled to the control module for switching at least one charging mode;
a detect module coupled to said circuit switch module to detect a circumstances of said multi-channel intelligent charger; and,
a charge module coupled to said detect module to output charging electric power.

2. The multi-channel intelligent charger of claim 1, wherein said circuit switch module comprises at least one transistor, a sort of the at least one transistor is selected form DEPFET, DGMOFET, FREDFET, HEMT, IGBT, MOSFET, NOMFET, MODFET, OFET, and the combination thereof.

3. The multi-channel intelligent charger of claim 1, wherein said multi-channel intelligent charger comprises a switch module, coupling the circuit switch module, controlling whether the electric power of the charge module is conductive or not.

4. The multi-channel intelligent charger of claim 3, wherein said switch module comprises at least one transistor, a sort of the at least one transistor is selected form DEPFET, DGMOFET, FREDFET, HEMT, IGBT, MOSFET, NOMFET, MODFET, OFET, and the combination thereof.

5. The multi-channel intelligent charger of claim 3, wherein said first charging voltage corresponding to a first battery is detected via said detect module, said circuit switch module activates a first switch unit, which charging current fed to said first battery is increased.

6. The multi-channel intelligent charger of claim 3, wherein said multiple batteries are detected via the detect module, the control module chooses to increase charging current fed to a lower residual power battery.

7. The multi-channel intelligent charger of claim 3, wherein said multiple batteries are detected via said detect module, said control module chooses to increase charging current fed to a higher residual power battery.

8. The multi-channel intelligent charger of claim 3, wherein said multiple batteries are detected via said detect module, said control module feeds charging current to all batteries simultaneously.

9. The multi-channel intelligent charger of claim 1, wherein said power module further comprising a rectifier unit, wherein said rectifier unit comprises a passive power factor correction circuit, or an active power factor correction circuit.

10. The multi-channel intelligent charger of claim 9, wherein a power factor of said active power factor correction circuit is between 0.65-0.85.
